(19) United States
(12) Patent Application Publication
(10) Pub. No.: US 2021/0217119 A1
(43) Pub. Date: Jul. 15, 2021

(54) INCARCERATION ALERT SYSTEM

(71) Applicant: BUSTED PRIME, LLC, Bellingham, WA (US)

(72) Inventor: Ziad I. YOUSSEF, Bellingham, WA (US)

(73) Assignee: BUSTED PRIME, LLC, Bellingham, WA (US)

(21) Appl. No.: 17/144,682

(22) Filed: Jan. 8, 2021

Related U.S. Application Data
(60) Provisional application No. 62/959,456, filed on Jan. 10, 2020.

(51) Int. Cl. G06Q 50/26; G06Q 50/18; G06Q 10/10; G06F 16/951

(52) U.S. Cl. CPC G06Q 50/26; G06F 16/951; G06Q 10/10; G06Q 50/18

(57) ABSTRACT

Provided is an incarceration alert system that can provide expedited assistance to an individual, such as an inmate. A user registers with the incarceration alert system and, as part of the registration, provides contacts to be monitored. The incarceration alert system then monitors various inmate processing systems for incarceration records related to the contact. When the incarceration alert system identifies a match between an incarceration record and a contact, the incarceration alert system identifies the contact as an inmate and notifies the user of the incarceration of the contact. In certain examples, the individual may register directly with the incarceration alert system to be monitored and/or receive legal services. In such examples, the incarceration alert system can provide the individual with a selectable list of attorneys that can quickly provide legal assistance. After receiving the individual's attorney selection, the incarceration alert system notifies the selected attorney of the selection.

### CROSS-REFERENCE TO RELATED APPLICATIONS

This application claims priority to U.S. Provisional Application No. 62/959,456 filed Jan. 10, 2020, titled “Incarceration Alert System.” The entire disclosure the above-identified applications is hereby fully incorporated herein by reference.

### TECHNICAL FIELD

The present disclosure relates generally to a method and system for providing alerts, and more particularly to quickly notifying a user that another user has been incarcerated or otherwise detained. Also provided are methods and systems to monitor whether a user has been incarcerated or detained, along with methods and systems to notify an inmate of a legal service provider that can assist the inmate.

### BACKGROUND

When an individual is arrested, they are generally processed at the police station affiliated with the arresting officer. And while the individual is generally allowed to make one or more telephone calls, for example, the individual's attorney is not necessarily notified of the arrest in a timely manner and thus cannot expeditiously begin to assist their client. This is especially problematic, for example, if the arrested individual does not have their attorney's contact information or if they are inebriated and cannot recall their attorney's name or other contact information. Likewise, if the individual lives away from their family, family members or other persons close to the individual—and authorized to monitor the individual—may not be notified of the arrest, at least in a timely manner. In some circumstances, an arrested individual may want to notify an attorney about their arrest, but they may not know—especially at the time of their arrest—the name or contact information for an attorney that could provide legal assistance. Systems and methods are thus needed to timely alert such persons that have a relationship with an arrested individual upon the individual's arrest. Systems and methods are also needed to quickly connect an arrested individual with an attorney that can provide relevant legal assistance.

### SUMMARY

In certain example aspects described herein, a computer-implemented method for providing an incarceration notification to a user is provided. For example, the user may wish to monitor another individual, such as an individual that has expressed a desire to be monitored. In such example aspects, an incarceration alert system receives a contact record from each of several of users, wherein each contact record identifies one or more contacts of each user. The incarceration alert system also receives an incarceration record for a recently incarcerated inmate, with the incarceration record identifying the inmate, such as by their name and/or birthdate. The incarceration alert system then compares the received incarceration record to one or more of the received contact records. For example, to make such a comparison the incarceration alert system can determine the content of the incarceration record and the contact record to compare their contents, thereby facilitating the determination of a content match that associates the user and the inmate. Hence, based on the comparison, the incarceration alert system determines a match between at least one of the contact records and the inmate. With this match, the incarceration alert system identifies at least one of the several users as being associated with the inmate and hence then provides a notification to the user regarding the inmate.

In certain example aspects, such as when one or more individuals desire to be monitored, the individual can register with the incarceration alert system to be monitored. Hence, in certain example aspects, provided is a computer-implemented method for providing an incarceration notification to a user that the individual identifies. For example, the incarceration alert system receives a contact record from a plurality of first users, wherein each contact record identifies one or more second users, such as with the second user being the individual that the first user wishes to receive the notification. The incarceration alert system then receives an incarceration record for a recently incarcerated inmate, wherein the incarceration record identifies one of the first users as the inmate. The incarceration alert system then compares the incarceration record to one or more of the received contact records.

Based on the comparison of the one or more contact records to the incarceration record, the incarceration alert system determines a match between at least one of the contact records and the inmate. With the match, the incarceration alert system can then identify at least one second user associated with the inmate and hence can provide a notification to the second user regarding the inmate. In certain example aspects, when the incarceration alert system compares the received contact record to the incarceration record, the incarceration alert system determines the content of the incarceration record and the contact record and comparing the contents to determine a content match. With the content match, for example, the incarceration alert system then identifies the first user that provided the contact record for the second user, thereby facilitating notification of the second use of the first user's incarceration.

In certain example aspects, a computer-implemented method for identifying a legal service provider for a first user is described. For example, an incarceration alert system receives a contact record from the first user that desires to be monitored, wherein the contact record identifies the first user. The incarceration alert system also receives a legal specialty indication from each of several second users, the second users being legal service providers. Thereafter, the incarceration alert system receives an incarceration record for a recently incarcerated inmate, wherein the incarceration record identifies the first user as the inmate and wherein the incarceration record identifies an offense type associated with the first user. The incarceration alert system then compares the offense type to one or more of the legal specialty indications and, based on the comparison of the offense type to the one or more of the legal specialty indications, determines a match between the offense type and at least one of the legal specialty indications. The incarceration alert system then identifies at least one of the several second users as having a legal specialty related to the offense type. Based on the identification of at least one of the second users, the incarceration alert system notifies the first user of the identified one or more second users, thereby connecting the first user to a second user that can assist the first user.

In certain example aspects, such as when the incarceration alert system identifies multiple second users having a specialty indication relevant to the offense type of the first user, the incarceration alert system can provide a selectable list of optional second users to the first user. The first user can then select one of the second users from the list. For example, the incarceration alert system receives a user input that selects one or more of the second users as a legal service provider. The incarceration alert system can then notify the second user of the selection. In certain example aspects, the incarceration alert system notifies one or more of the second users of the first user's incarceration.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for providing an incarceration alert to a user, in accordance with certain example embodiments.

FIG. 2 is a block flow diagram depicting a method for providing an incarceration alert to a user, in accordance with certain example embodiments.

FIG. 3 is a block flow diagram depicting a method for identifying a match between a user contact record and an inmate incarceration record, in accordance with certain example embodiments.

FIG. 4 is a block diagram depicting an example hardware implementation, in accordance with certain example embodiments.

### DETAILED DESCRIPTION OF THE EXAMPLE EMBODIMENTS

### Overview

As disclosed herein, provided is an incarceration alert system that can monitor an individual, such as an inmate, to provide expedited assistance to the individual. For example, a user registers with the incarceration alert system and, as part of the registration, provides contacts to be monitored. The incarceration alert system then monitors various inmate processing systems for incarceration records that may be related to the contact. When the incarceration alert system identifies a match between a received incarceration record and a contact, the incarceration alert system identifies the contact as an inmate. The incarceration alert system then notifies the user of the incarceration of the contact (as the inmate) so that the user can assist the contact. In certain examples, the individual may register directly with the incarceration alert system so that they can be monitored and/or receive legal services. For example, the incarceration alert system can provide the individual with a list of attorneys that can quickly provide legal assistance.

More particularly, in certain examples, such as when a user seeks to monitor another individual, the user provides information to the incarceration alert system in order to register with the incarceration alert system. For example, the user may provide their name, email address, and phone number, as well as a username and password to access an account of the incarceration alert system. The user may also identify their profession and/or specialty, such as “attorney with DUI experience.” Based on the user's information, the incarceration alert system creates an account for the user that includes the user's information. Thereafter, the user can provide contact records for one or more individuals that the user intends to have monitored. And those skilled in the art will appreciate based on this disclosure, the incarceration alert system can register multiple users and hence receive multiple contact records for individuals to be monitored. In certain examples, the individual to be monitored may provide consent to be monitored and/or affirmatively request to be monitored.

Once the incarceration alert system receives a contact from the registered user, the incarceration alert system can identify an incarcerated inmate matching a contact record with the inmate. For example, the incarceration alert system can optionally register with one or more inmate processing systems, such as a processing system at a jail or other detention facility. Additionally or alternatively, the incarceration alert system can use a web crawler to obtain public information from various inmate processing systems. The incarceration alert system can then read the information for any identified incarceration record. For example, the incarceration alert system compares to the content of the contact records from the user with identified incarceration records so that it can identify a match between one of the contacts and an individual associated with the incarceration record. If the incarceration alert system identifies a match, the incarceration alert system can identify the contact as the inmate.

After determining that the inmate matches a contact provided by the user, the incarceration alert system can identify the user associated with the contact. For example, when the incarceration alert system has many stored user accounts, the incarceration alert system can determine from the information in the user accounts which user provides the contact corresponding to the inmate, such as by reading the information associated with the various user accounts. Thereafter, the incarceration alert system can notify the user of the incarceration of the inmate. For example, by reading the information associated with the user account, the incarceration alert system can text, call, or otherwise notify the user of the inmate's incarceration. In certain examples, if the user has identified other individuals to be contacted upon, the incarceration alert system can—by reading the information associated with the user account—determine the contact information for such other individuals and hence also notify those individuals. As such, in some examples the incarceration alert system can be used to notify both the user and others of the inmate's incarceration.

Additionally or alternatively, in certain examples an individual that wishes to be monitored may establish a user account with the incarceration alert system to be monitored. In such examples, the methods and systems described herein can be readily adapted to accommodate the user. For example, the user can provide information to the incarceration alert system to establish the user account and hence register with the incarceration alert system. The user can then provide one or more contacts that the user desires to be contacted should the user be incarcerated. For example, the user may provide the contact information of an attorney of the user and/or a parent or other guardian. In certain examples, the contact will provide consent to participate with the incarceration alert system.

Once the user to be monitored has created a user account with the incarceration alert system, the incarceration alert system monitors various inmate processing systems as described above for an incarceration record identifying the user. For example, the incarceration alert system reads one or more obtained incarceration records for information that identifies the user as the contact, such as by comparing the content of the incarceration records to the content of the user account associated with the user. By matching the content, the incarceration alert system identifies the user as the inmate. The incarceration alert system can read the contacts provided by the user to identify the contacts and then notify the contacts of the user's incarceration. For example, the incarceration alert system can call, text, or otherwise notify the contacts regarding the user's incarceration.

In certain examples, the methods and systems described herein can be used to provide legal services to an individual in need thereof. For example, a first user, such as a user that wishes to be monitored for needing legal services, can create a user account with the incarceration alert system as described above and register with the incarceration alert system. As part of the registration, for example, the first user can identify one or more contacts to be notified should the first user be incarcerated. In certain examples, the first user may indicate that they do not have a specific attorney but desire to be connected to an attorney should a legal need arise. Additionally or alternatively, one or more second users registers with the incarceration alert system, such as by providing their contact information and legal specialty area. For example, the second user may note that they are an attorney with “DUI” experience. The incarceration alert system then retrievably records the first user information and the second user information, including the specialty area information from the second user.

Thereafter, the incarceration alert system monitors the first user as described herein, such as by obtaining incarceration records from one or more inmate processing systems. For example, as the incarceration alert system receives incarceration records, the incarceration alert system reads the incarceration records for content matching the content that the first user provided. If a match occurs, the incarceration alert system identifies the first user as the inmate. And based on the contacts that the first user provided and that are hence associated with the user account of the first user, the incarceration alert system identifies the first user as the inmate. The incarceration alert system can then notify any contacts of the first user of the first user's incarceration, such as by texting or calling the contact.

Additionally or alternatively, the incarceration alert system can provide the first user with one or more second users that can assist the first user. For example, when the incarceration alert system reads the incarceration record associated with the first user, the incarceration alert system can determine the offense for which the first user was incarcerated. The incarceration alert system can then determine a match between the offense type and the specialty area indications that the second users provided, such as by reading the information provided by the one or more second users. For example, if the incarceration alert system determines that the first user was arrested for DUI, the incarceration alert system may identify one or more second users with DUI experience. The incarceration alert system can then notify the first user of the one or more second users that can assist the first user with the DUI arrest.

In certain examples, the incarceration alert system can include in the notification to the first user a selectable list of second users that can assist the first user. For example, the incarceration alert system may notify the first user of three second users that are attorneys with DUI defense experience, the notification being a text or email with contact information for the three second users. Hence, the first user can then contact one of the second users for assistance. In certain examples, the list of second users can be a selectable list that allows the first user to select one of the second users. For example, if the notification is provided on a user device of the first user, the user may select one of the second users via a user control option. The incarceration alert system then receives the first user's selection, and—based on the selection—can notify the selected second user of the selection. For example, upon receipt of the first user's selection, the incarceration alert system can call, text, or email the second user, thereby notifying them that the first user needs legal assistance.

By using the methods and systems described herein, an individual that is arrested can quickly receive legal assistance and notify those of the arrest, thus greatly benefiting the individual. For example, if an attorney registers with the incarceration alert system to monitor a client, when the client is incarcerated and becomes an inmate, the attorney user can quickly be notified that the client was arrested. The attorney can then quickly act to assist the client. In examples where an individual registers directly with the incarceration alert system to be monitored, the methods and systems provided herein can be used to quickly notify any contacts of the individual—such as an attorney and/or guardian—of the individual's incarceration. And depending on the individual's preferences, for example, in some examples when the individual is arrested they can—and addition to notifying a friend or family member, for example—receive a list of attorneys with a relevant expertise in the legal area needed. As such, the individual can quickly receive any needed legal support whereas such support would otherwise be delayed. These and other benefits are described and made apparent herein.

### Example System Architecture

Turning now to the drawings, in which like numerals indicate like (but not necessarily identical) elements throughout the figures, example embodiments are described in detail.

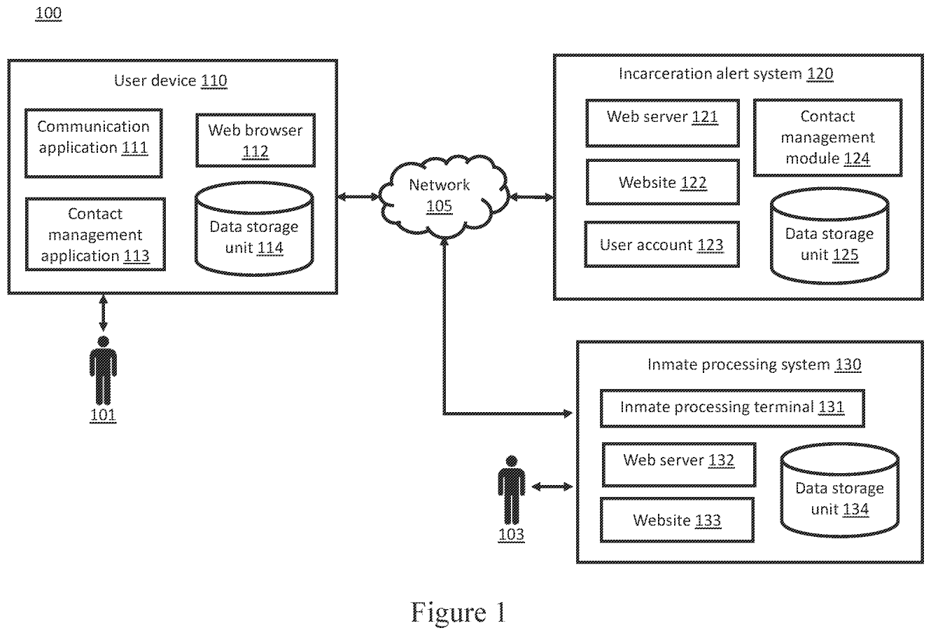

FIG. 1 is a block diagram depicting a system for providing an incarceration alert to a user, in accordance with certain example embodiments. As depicted in FIG. 1, the exemplary operating environment 100 includes a user network computing device 110, an incarceration alert system 120, and an inmate processing system 130 for processing an inmate 103.

Each network 105 includes a wired or wireless telecommunication means by which network devices (including devices 110, 120, and 130) can exchange data. For example, each network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN) a mobile telephone network, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment. In some embodiments, a user 101 associated with a device must install an application and/or make a feature selection to obtain the benefits of the techniques described herein.

Further, in some embodiments an inmate 103 must opt-in to any monitoring, such as by enrolling with the incarceration alert system 120 or otherwise notifying the incarceration alert system 120 of an intention to be monitored. It will also be appreciated by those skilled in the art that, while the term “incarceration” is used throughout herein, that term does not require actual confinement to a jail, prison cell, mental hospital, etc. Rather, as used herein, the terms “incarceration” or the like refer more broadly to taking an individual into custody and hence holding the individual in any capacity against their will and/or depriving them of their personal freedoms. Such persons, for example, are also broadly referred to as an inmate 103.

Each network device 110, 120, and 130 includes a device having a communication module capable of transmitting and receiving data over the network 105. For example, each network device 110, 120, and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 120, and 130 are operated by end-users or consumers, incarceration notification system operators, and police departments or other detention facility personnel, respectfully.

The user device 110 can include, for example, a communication application 111 and associated web browser 112 that can interact with web servers or other computing devices connected to the network 105. For example, the user 101 can use the communication application 111 of the user device 110, such as a web browser 112 application or a stand-alone application, to view, download, upload, or otherwise access documents, web pages, or digital images via a distributed network 105. The user 101 of the user device 110 can also, for example, use the communication application 111 and web browser 112 to access the incarceration alert system 120, such as to create a user profile or account with the incarceration alert system 120 and to communicate a contact record of the user 101 to the incarceration alert system 120. In certain example embodiments, the user device 110 can include a contact management application 113, which represents the component of the user device 110 that allows the user 101, for example, to input contacts of the user 101 into the user device 110 and to store the contacts. For example, a user 101 that is an attorney or other legal service provider may include in the contact management application 113 one or more clients, including clients that user 101 attorney intends to enroll with the incarceration alert system 120. As shown in FIG. 1-3, for example, the user 101 can be an individual that wishes to be notified when another individual is arrested. In other example embodiments, the user 101 can be an individual that desires to be monitored so that, if they later become an inmate 103, another, second user 101 of the methods and systems described herein can be notified.

In certain example embodiments, the user device 110 can include a data storage unit 114 for use in storing retrievable information, such as contact information that is stored on the user device 110 and associated with the contact management application 113. The example data storage unit 114 can include one or more tangible computer-readable media and can be either stored on the user device 110 or logically coupled to the user device 110. The data storage unit 114 can include on-board flash memory and/or one or more removable memory cards or removable flash memory. As those skilled in the art will appreciate, other customary electronic components (not shown) may be associated with the user device 110.

The incarceration alert system 120 represents the component of the exemplary operating system 100 responsible for receiving user information, receiving contact records from the user device 110, receiving inmate 103 information from the inmate processing system 130, and determining a match between a contact record of the user 101 and the inmate 103, as described herein. The incarceration alert system 120 is also responsible, for example, for notifying the user 101 that the inmate 103 has been incarcerated, as described herein. In certain example embodiments, the incarceration alert system 120 represents the component of the exemplary operating system 100 responsible for identifying a legal service provider, such as an attorney, for a user 101. The example incarceration alert system 120 also includes a web server 121 and associated website 122 that allows a user 101, for example, to provide a user profile of the user 101 to the incarceration alert system 120, such as to set up a user account 123 with the incarceration alert system 120. That is, the web server 121 can provide content to the website 122 such that the user 101 can input information into a user interface of the website 122, thereby providing information to the incarceration alert system 120 about the user 101.

Likewise, an operator of the inmate processing system 130 may access the incarceration alert system 120 via the web server 121 and a user interface of the associated website 122 to provide information about an inmate 103. In certain example embodiments, the web server 121 can include a web crawler component to gather information about one or more inmates 103, such as whether the inmate 103 has recently been incarcerated. An inmate is recently incarcerated, for example, if they were arrested within the past 5, 10, 15, 20, 24, 48, 72, or 96 hours or at times in between. In other example embodiments, a recently incarcerated inmate may have been arrested and recently incarcerated within the past week.

In certain example embodiments, the incarceration alert system 120 can also include one or more user accounts 123 that include information from one or more users 101 that have enrolled with the incarceration alert system 120. For example, a user 101 may provide information about the user 101 as described above to create a specific profile for the user 101 with incarceration alert system 120. The incarceration alert system 120 can then organize and associate the received information with the user 101 in the user account 123 of the user 101. Likewise, in certain example embodiments the incarceration alert system 120 can include a contact management module 124, which represents a repository of various contacts that the incarceration alert system 120 has received from one or more users 101 or legal service providers. For example, as part of enrolling with the incarceration alert system 120 and creating a user account 123, a user 101 can provide one or more contact records for a contact that the user 101 intends the incarceration alert system 120 to monitor. The incarceration alert system 120 can then associate one or more received contact records with the contact management module 124.

As shown in FIG. 1, in certain example embodiments, the incarceration alert system 120 can include a data storage unit 125 for use in storing retrievable information. For example, the data storage device 125 can store information associated with the user account 123, such as information identifying the user 101 and the information used to create a user account 123 of the user 101. The data storage unit 125 can also serve as the storage component of the contact management module 124 by storing received contact records associated with the contact management module 124. The example data storage unit 125 can include one or more tangible computer-readable media and can be either stored on the incarceration alert system 120 or logically coupled to the incarceration alert system 120. The data storage unit 125 can include on-board flash memory and/or one or more removable memory cards or removable flash memory. As those skilled in the art will appreciate, other customary electronic components (not shown) may be associated with the incarceration alert system 120.

The inmate processing system 130 represents the component of the exemplary operating system 100 responsible for receiving and storing inmate 103 information and then communicating that information to the incarceration alert system 120. For example, as an inmate 103 is “booked” into a police department following an arrest, the inmate processing system 130 can receive information regarding the inmate 103. In certain example embodiments, the inmate processing system 130 includes an inmate processing terminal 131, which can function as a portal by which the inmate processing system 130 receives the inmate information. For example, an operator (not shown) of the inmate processing system 130 may enter information regarding the inmate 103 into a user interface of the inmate processing terminal 131. Additionally or alternatively, an arresting officer may enter information about the inmate into the inmate processing system 130 via the inmate processing terminal 131. In certain example embodiments, the inmate processing terminal 131 may be remotely connected to the inmate processing system 130, such as via the network 105. For example, the arresting officer may enter information regarding the inmate 103 into a mobile device associated with the officer and/or his squad car, the information thereafter being commuted to the inmate processing system 130 via the network 105.

As shown, the inmate processing system 130 can also include a webserver 132 and an associated website 133. The webserver 132, for example, can provide content to the website 133 of the inmate processing system 130, such as information about one or more processed inmates 103. For example, the inmate processing system 130 may publish information about one or more inmates that have recently been arrested. The web server 121 of the incarceration alert system 120 can then, for example, access the website 133 of the inmate processing system 130 to obtain the information regarding the one or more inmates 103. The inmate processing system 130 can also include a data storage unit 134 that is responsible for storing information associated with the inmate processing system 130, such as information regarding one or more inmates 103 that have been processed with the inmate processing system 130. The example data storage unit 134 can include one or more tangible computer-readable media and can be either stored on the inmate processing system 130 or logically coupled to the inmate processing system 130. The data storage unit 134 can include on-board flash memory and/or one or more removable memory cards or removable flash memory. As those skilled in the art will appreciate, other customary electronic components (not shown) may be associated with the inmate processing system 130.

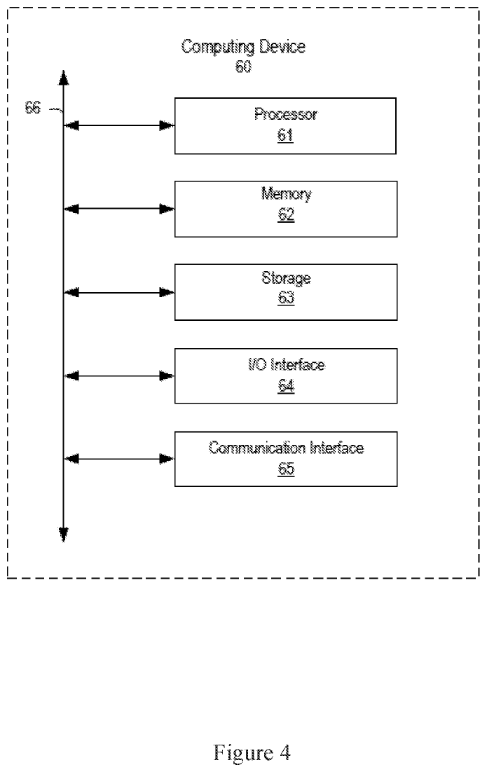

It will be appreciated that the network connections shown in FIG. 1 are exemplary and that other means of establishing a communications link between the computers and devices can be used. Moreover, those having ordinary skill in the art having the benefit of the present disclosure will appreciate that the user device 110, the incarceration alert system 120, and the inmate processing system 130 illustrated in FIG. 1 can have any of several other suitable computer system configurations. For example, a user device 110 embodied as a mobile phone or handheld computer may or may not include all the components described herein. Further, in certain example embodiments, one or more of the several components presented herein may be any type of computing device, including for example those discussed in more detail with respect to FIG. 4. Likewise, any modules or applications discussed herein or any other modules (scripts, web content, software, firmware, or hardware) may be performed or accomplished by any modules or application detailed in FIG. 4.

### Example Processes

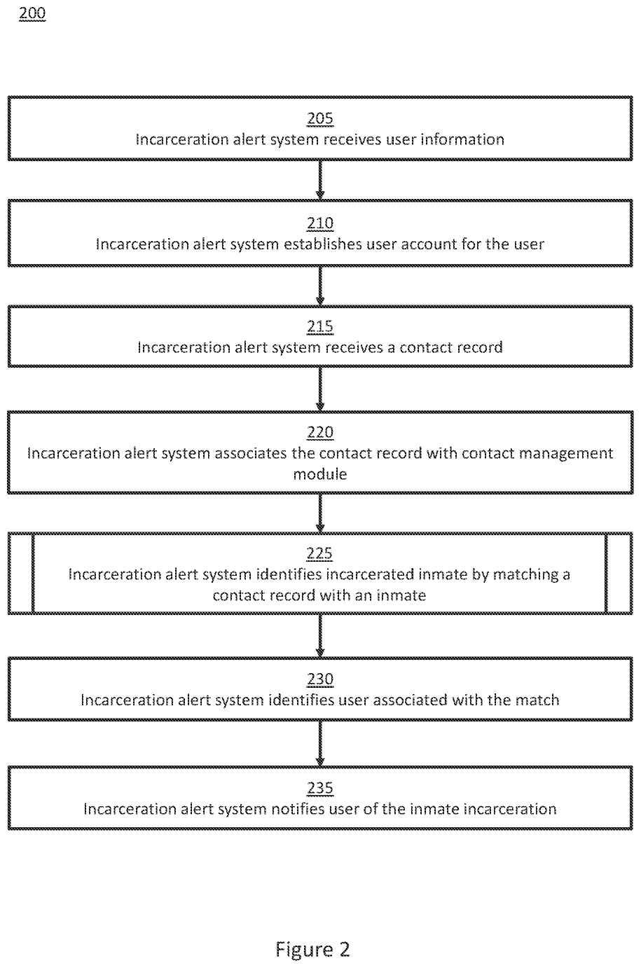

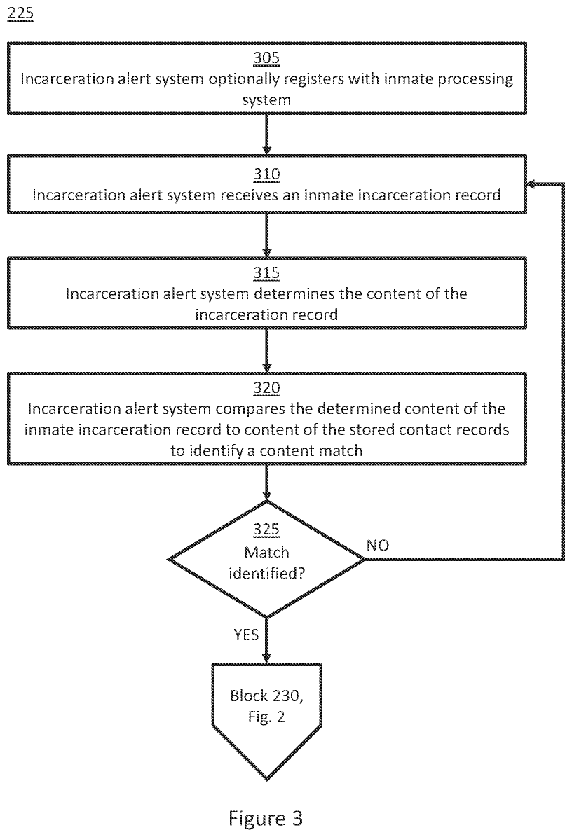

The components of the example operating environment 100 are described hereinafter with reference to the example methods and diagrams illustrated in FIGS. 2-3. The example methods of FIGS. 2-3 may also be performed with other systems and in other environments.

FIG. 2 is a block flow diagram depicting a method for providing an incarceration alert to a user 101, in accordance with certain example embodiments.

With reference to FIGS. 2 and 3, in block 205 of FIG. 2, the incarceration alert system 120 receives user 101 information. That is, a user 101 wishing to monitor another individual, such as an individual that has asked to be monitored or otherwise consented to be monitored, provides identifying information to the incarceration alert system 120 so that the incarceration alert system 120 can establish a user account 123 with the incarceration alert system 120. For example, the user 101 accesses the web browser 112 of the user device 110 and, via the communication application 111 and the network 105, accesses the website 122 of the incarceration alert system 120. The user 101 can then input identifying information into a user interface of the website 122 of incarceration alert system 120, such as the user's name, address, mobile telephone number, email address, and/or other user information that can identify the user 101. In certain example embodiments, the user 101 can provide preferred contact information for receiving notifications from the incarceration alert system 120, such as a preference to receive a phone call and/or text message. The user 101 can also provide various user log-in credentials to the incarceration alert system 120, such as a user name and password, that the user 101 intends to use when accessing their user account 123 associated with the incarceration alert system 120. With the user information, for example, the incarceration alert system can later notify the user 101 when the individual the user 101 wishes to monitor is, for example, incarcerated and becomes an inmate.

In block 210, the incarceration alert system 120 establishes a user account 123 for the user 101. That is, using the information received from the user 101, the incarceration alert system 120 creates a record that associates user 101 with the information provided by the user 101, thereby registering the user 101. The information provided by the user 101, for example, can be stored on the data storage unit 125 of the incarceration alert system 120 and can be then be accessed, for example, as part of the user account 123 for the user 101. In certain example embodiments, and as one skilled in the art will appreciate based on this disclosure, it is contemplated that multiple users 101 can create multiple user accounts 123 with the incarceration alert system 120, with the information provided by each user 101 being retrievably stored on the data storage unit 125. Further, once a user 101 creates a user account 123, in certain example embodiments the user can access the account, for example, from the user device 110 and via the network 105, in order to update the account information, change or modify their user credentials, or to take other actions associated with their specific user account 123 with the incarceration alert system 120. In certain example embodiments, the information received for the user account 123 can be stored in the data storage unit of the incarceration alert system 120.

In certain example embodiments, the user 101 may access the user account 123 to specify other individuals that the user 101 wants to receive alerts from the incarceration alert system 120 as described herein. For example, if the user 101 is an attorney and wants to monitor whether a client is arrested, the attorney user 101 may also specify, at the request of the client, that the client's spouse also be notified of the client's incarceration as described herein. Hence, when the client is arrested as described herein, the attorney user 101 in this example the client's spouse can each receive an alert from the incarceration alert system 120 as described herein. If the user 101 is a parent of a child to be monitored, then the parent user 101 may also add their spouse to the user account to hence also receive an alert from the incarceration alert system 120 as described herein.

In block 215, the incarceration alert system 120 receives a contact record from the user 101. That is, the user 101 provides identifying information and content to the incarceration alert system 120 for an individual that the user 101 intends the incarceration alert system 120 to monitor. For example, if the user 101 is a parent that intends to use the incarceration alert system 120 to monitor their child for incarceration, the user 101 can provide a contact record for the child to be monitored. If the user 101 is an attorney or other legal service provider that wishes to be alerted if a client is incarcerated, for example, the attorney user 101 can provide a contact record to the incarceration alert system 120 for the client to be monitored. In certain example embodiments, the child, client, or other individual to be monitored may provide consent for the monitoring, such as accessing the website 122 and providing the consent. In other example embodiments, the incarceration alert system 120 may provide a text, email, push notification, or other communication in which the individual may opt in to the incarceration alert system 120 monitoring. That is, in some example embodiments, when the user 101 provides a contact record to the incarceration alert system 120 via the user device 110 and the network 105, for example, the incarceration alert system 120 can provide a text or other message to the individual asking the individual to confirm their participation in the incarceration alert system 120 monitoring (and hence consent for monitoring). The incarceration alert system 120 can then store the confirmation with the user account 123 of the user 101.

The contact record for the individual to be monitored can include a variety of content, such as the name of the individual to be monitored, their telephone number and/or email address, their residency address, and/or any other personally identifying content such as a social security number, drivers license number, birthdate, or state/federal identification number. For example, if a client named JOHN A. DOE informs their attorney JANE A. SMITH of a desire to be monitored, JANE A. SMITH can provide a contact record for JOHN A. DOE to the incarceration alert system 120 for monitoring, such via an input in to a user interface of the user device 110 and via the network 105. For example, to provide the contact record, the user 101, such as JANE A. SMITH in the above example, can access the contact management application 113 of the user device 110, select the desired contact, and then share the contact record with the incarceration alert system 120 via the network 105. The incarceration alert system 120 then receives the contact record via the network 105, including any content associated with the contact record. Additionally or alternatively, the user 101 may access the website 122 and their individual user account 123 of the incarceration alert system 120 to input a contact record into a user interface (not shown) of the incarceration alert system 120, thereby allowing the incarceration alert system 120 to receive the contact record via a user input. Additionally or alternatively, the user 101 may call an operator (not shown) of the incarceration alert system 120 to provide contact information for a contact record of the user 101. In such example embodiments, the operator can input the contact record into the incarceration alert system 120.

In block 220, the incarceration alert system 120 associates the contact record with contact management module 124. That is, after the incarceration alert system 120 receives the contact record from the user 101, such as via the network 105, the incarceration alert system 120 can enter the content of contact record with the management module 124 so that the contact record can later be retrieved, read, and compared to an incarceration record as described herein. For example, if the incarceration alert system 120 receives a contact record for JOHN A. DOE, the incarceration alert system 120 can associate the name JOHN A. DOE with the contact management module 124, so that the name JOHN A. DOE can later be identified and/or retrieved. In certain example embodiments, the content of the contact records associated with the contact management module 124 can be retrievably stored in the data storage unit 125 of the incarceration alert system 120. For example, the incarceration alert system 120 can receive the contact record as described herein via the network 105 and then store the contact record with the data storage unit 125. The contact management module 124 can then access the contact records stored on the data storage unit 125 of the incarceration alert system 120.

In block 225, the incarceration alert system 120 identifies an incarcerated inmate by matching a contact record with an inmate. Briefly, the incarceration alert system 120 optionally registers with the inmate processing system 130 and receives an inmate incarceration record associated with one or more inmates. The inmate incarceration record can include, for example, any information that an inmate processing system 130, such as a jail or other detention facility, has or obtains for the inmate. The incarceration alert system 120 then compares the inmate incarceration record with the stored contact records to identify a match between the content of the incarceration record and the content of the user-provided contact record. If the incarceration alert system 120 identifies a match, then the method proceeds to block 230 of FIG. 2. But if the incarceration alert system 120 does not identify such a match, then the incarceration alert system 120 can continue to compare additionally received incarcerations to identify a match with the contact record of the user 101. The details of block 225 are described in further detail below with reference to FIG. 3.

Turning to FIG. 3, shown is a block flow diagram depicting a method for identifying a match between a user contact record and an inmate incarceration record, in accordance with certain example embodiments. In block 305 of FIG. 3, the incarceration alert system 120 optionally registers with inmate processing system 130. That is, the incarceration alert system 120, such as at the direction of an operator (not shown) of the incarceration alert system 120, establishes an association with the inmate processing system 130 so that the incarceration alert system 120 can receive inmate incarceration records from the inmate processing system 130. For example, the incarceration alert system 120 and inmate processing system 130 may exchange an interface specification, such as an application programing interface (“API”), that allows secure communication between the incarceration alert system 120 and the inmate processing system 130. Using the API, for example, the inmate processing system 130 can, via the network 105, securely provide inmate incarceration records to the incarceration alert system 120. In certain example embodiments, the inmate processing system 130 can contact the incarceration alert system 120, such as via the network, and hence register with the incarceration alert system 120. Either way, the registration process creates an association between the incarceration alert system 120 and the inmate processing system 130.

In certain example embodiments, such as when the inmate processing system 130 and the incarceration alert system 120 do not form a formal association via the registration process described herein, the incarceration alert system 120 may obtain public information from the inmate processing system 130. For example, if the inmate processing system 130 publishes an online list of recently arrested inmates on its website 133, the incarceration alert system 120 may access the public information, thereby removing the need for registration between the incarceration alert system 120 and the inmate processing system 130. Hence, the registration of the incarceration alert system 120 with the inmate processing system 130, or vice versa, is optional.

In block 310, the incarceration alert system 120 receives an inmate incarceration record. That is, the incarceration alert system 120 obtains information about an inmate 103 that, for example, allows the incarceration alert system 120 to identify a user 101 associated with the inmate 103 as described herein. For example, when an inmate 103 is booked into an inmate processing system 130, such as a jail or other detention facility, an operator (not shown) of the inmate processing system 130 can input information about the inmate into the incarceration alert system 120, such as via a user interface of the inmate processing terminal 131. The information identifying the inmate 103 can include, for example, the inmate's name and/or their address, telephone number, social security number, drivers license number, and/or any other identifying information.

An operator (not shown) of the incarceration alert system 120 can also enter additional information into the inmate processing terminal 131 for the inmate 103, such as arrest origin (e.g., the police department name and/or address), the name and address of the police station where the inmate 103 is being detained, an event number that may link the inmate 103 to other inmates associated with the same event, the type of arrest and/or a description of the offense (e.g., Traffic, DUI, Alcohol), a case number for the inmate 103, the court associated with the inmate's case, the bail type or amount, any current or expected disposition of the case, and/or any other pertinent information to the inmate, all or part of which can be included as part of the inmate's incarceration record. The entered information may also include the name and/or contact information for the inmate's attorney, next of kin, and/or other individual that the inmate 103 identifies. Thereafter, in certain example embodiments the incarceration alert system 120 can obtain all or part of the inmate's information, as the inmate incarceration record, for use with the methods and systems described herein. For example, if the incarceration alert system 120 has registered with the incarceration alert system 120, the incarceration alert system 120 can obtain the inmate incarceration record via an API as described in block 305, with the incarceration alert system 120 providing the inmate incarceration record to the incarceration alert system 120 via a secured connection over the network 105.

Additionally or alternatively, and as briefly discussed above, the incarceration alert system 120 may obtain an inmate incarceration record via a publicly available inmate incarceration record associated with the inmate processing system 130. For example, various police departments in the United States frequently release a log of recent arrests on webpages of their website 133. In fact, such arrest logs, also known as “booking reports,” “jail reports,” “jail bookings,” “jail rosters,” or the like, are often published via the network 105 daily and include information comprising an inmate incarceration record as described herein. The published arrest logs, such as those published on a website 133 of an inmate processing system 130 associated with a police station, can thus be received and read for their content. That is, to receive the inmate incarceration record, the web server 121 of the incarceration alert system 120 can access one or more websites 133 of one or more inmate processing systems 130 via the network 105, thereby obtaining various inmate incarceration records and hence receiving the inmate incarceration record(s) according to block 310. For example, a web crawler associated with the incarceration alert system 120 can scan and review various arrest logs from several police stations, thereby allowing the incarceration alert system 120 to broadly monitor inmate incarcerations.

In block 315, the incarceration alert system 120 determines the content of the incarceration record. That is, after the incarceration alert system 120 receives the inmate incarceration record as described herein, the incarceration alert system 120 reads the inmate incarceration record to determine and identify specific information that can be used to identify a match to a stored contact record. For example, if the incarceration record includes the name of an inmate, their address, and their local court case number, the incarceration alert system 120 determines this or other information from the inmate incarceration record. As an example, if an individual named “JOHN A. DOE” was arrested on Nov. 1, 2019, and the inmate incarceration record identifies the inmate 103 as a JOHN A. DOE arrested on Nov. 1, 2019, then the incarceration alert system 120 reads the inmate incarceration record to determine that a “JOHN A. DOE” was arrested on Nov. 1, 2019. In certain example embodiments, the incarceration alert system 120 may store the determined content from the inmate incarceration record in the data storage unit 125 of the incarceration alert system 120 for later retrieval and processing.

In block 320, the incarceration alert system 120 compares the determined content of the inmate incarceration record to the content of the stored contact records to identify a content match. That is, based on the determined content of the inmate incarceration record, the incarceration alert system 120, such as via the contact management module 124, reads the contact records associated with the contact management module 124 in order to identify a contact record that references or otherwise identifies the inmate 103 identified in the inmate incarceration record content. For example, and continuing with the above example, if a user 101 named JANE A. SMITH has provided a contact record identifying JOHN A. DOE to the incarceration alert system 120 as described herein, then the incarceration alert system 120 can associate the JOHN A. DOE contact record with user JANE A. SMITH in the contact management module 124 of the incarceration alert system 120, such as when JANE A. SMITH provides her contact record(s) as described herein. Thereafter, when the incarceration alert system 120 receives an incarceration record for a “JOHN A. DOE,” the incarceration alert system 120 can determine that the contact record identifies JOHN A. DOE as an inmate 103, and hence can compare that determined content, i.e., the name JOHN A. DOE, to the content of the contact records associated with the contact management module 124. In certain example embodiments, the incarceration alert system 120 may use multiple items of information to identify a content match. For example, the incarceration alert system 120 may use both a received name and birthdate for the inmate to match content to a name and birthdate stored in the contact record provided by a user. As those skilled in the art will appreciate, such use of additional information can improve the accuracy of a content match between the information in the received incarceration record and the received and stored contact records.

If the incarceration alert system 120 identifies a match between identified content of an inmate incarceration record and one or more of the contacts associated with the contact management module 124, the method follows from block 320 through the “YES” branch of block 325 to block 230 of FIG. 2. For example, if the incarceration alert system 120 identifies a matching JOHN A. DOE name between the content of the of a received inmate incarceration record and the contact records of the contact management module 124, the method proceeds to block 230 of FIG. 2. But if the incarceration alert system 120 does not identify such a match, the method follows from block 320 through the “NO” branch of block 325 back to block 310. That is, if a match is not identified, the incarceration alert system 120 continues to receive inmate incarceration records and to evaluate those records for possible matches as described in FIG. 3.

Returning to FIG. 2, in block 230 of FIG. 2. The incarceration alert system 120 identifies the user 101 associated with the match. That is, based on the determined content match, the incarceration alert system 120 determines the identity of the user 101 that provided the contact record associated with the content match (and that hence is associated with the user 101). For example, if both the content of a stored contact record and the content of an inmate incarceration record include a “JOHN A. DOE” as the content match, and if JANE A. SMITH provided the contact record including the JOHN A. DOE content, then the incarceration alert system 120 identifies JANE A. SMITH as the user 101 associated with the content match. Likewise, if the content match includes additional and/or different information, such as the social security number for an inmate, then the incarceration alert system 120 can identify the relevant user 101 by determining the user 101 that provided the social security number to the incarceration alert system 120. As such, based on the content match between the received incarceration record in the stored contact records, the incarceration alert system 120 can determine which user 101 provided the contact record (see blocks 205-215) and hence identify the user 101 that wished to be notified of the incarcerated inmate.

In block 235, the incarceration alert system 120 notifies the user 101 of the inmate's incarceration. That is, after identifying the user 101 associated with the content match, the incarceration alert system 120 determines the contact information for the user 101 that the user previously provided to the incarceration alert system 120. For example, the incarceration alert system 120 reads the contact record associated with the content match to identify contact information for the user 101, such as the user's mobile telephone number or other contact information. The incarceration alert system 120 can then contact the user 101 via the mobile telephone number, such as via a phone call, a text, or any other method, such as via the network. In certain example embodiments, the incarceration alert system 120 reads the contact record and/or information from the user account 123 of the user 101 to determine the user's preferred contact means. The incarceration alert system 120 then notifies the user 101 of the incarceration of the inmate 103, thereby alerting the user 101. And, depending on other individuals that the user 101 has identified as recipients of the notification, the incarceration alert system 120 can notify such recipient. For example, if the user is JANE A. SMITH and the inmate is JOHN A. DOE, the incarceration alert system 120 can notify JANE A. SMITH of JOHN A. DOE's incarceration. And if JOHN A. DOE has, for example, previously requested that their parent be notified, the incarceration alert system 120 can notify the parent. For example, if the parent's mobile number has been entered into the user account 123, the incarceration alert system 120 can notify the parent via the stored mobile number, such as via the network 105.

In certain example embodiments, in addition to notifying the user 101 of the inmate incarceration, the incarceration alert system 120 can provide the user 101 with additional content determined from reading the inmate incarceration record. For example, in addition to notifying the user 101 of the inmate's incarceration, the incarceration alert system 120 can provide the inmate's arrest origin (e.g., the police department name and/or address), the name and address of the police station where the inmate 103 is being detained, an event number that may link the inmate 103 to other inmates associated with the same event, the type of arrest and/or a description of the offense (e.g., Traffic, DUI, Alcohol), a case number for the inmate 103, the court associated with the inmate's case, the bail type or amount, any current or expected disposition of the case, and/or any other pertinent information regarding the inmate. And, such other information can also be provided to other individuals that the user 101 has identified as recipients of the information.

By notifying the user 101 of the incarceration of the inmate 103, the user 101 can take whatever steps are needed to help and/or assist the inmate 103 in a timely manner. For example, if the user 101 is an attorney or other legal service provider and the inmate 103 is their client, then—once notified of the inmate's incarceration—the attorney can quickly provide legal aid to the inmate 103. If the notification includes the court where the inmate 103 is to appear, for example, the attorney can quickly file any motions and/or take any actions with the court to assist the client. Likewise, if the user 101 is a parent and their child is the inmate 103, the parent—upon notification of their child's incarceration—can quickly take steps to assist their child. For example, the parent may provide bail funds to the child or contact the child's attorney.

### Additional Example Processes

In certain example embodiments, the methods and systems described herein in FIGS. 1-3 can be readily modified and/or adapted to allow a child or other individual to request monitoring by the incarceration alert system 120. That is, an individual, such as a child, relative, or other individual, may wish to notify a user 101 when they are incarcerated, and hence initiate enrollment in the incarceration alert system 120. For example, a child may wish to notify their parent if they are arrested or a client may wish to notify their attorney or other legal service provider if they are arrested. Hence, as those in that art will appreciate based on this disclosure, the methods disclosed herein can be adapted to accommodate such embodiments where such child or other individual initiates the enrolment with the incarceration alert system 120 so that they can be monitored.

For example, a child or young adult operating as a first user 101 may contact the incarceration alert system 120 via the network 105 as described herein, such as by accessing the website 122 of the incarceration alert system 120 via the network 105 and inputting information into a user interface of the incarceration alert system 120 to create user account 123 for the first user 101. The incarceration alert system 120 then receives the information via the network 105. The information for the first user 101 can, for example, operate as contact record described herein, which can be associated with the contact management module 124 of the incarceration alert system 120, as described herein. The first user 101 can also provide identifying information for a second user 101 that should be contacted if the first user 101 is incarcerated and hence becomes an inmate 103. For example, the first user 101 may provide the name of the second user 101, an email address, and/or mobile phone number of the second user 101 (or any other contacting means) to the incarceration alert system 120 via the network 105. As an example, a child may provide the contact information for their parent or other relative and a client may provide the contact information for their attorney. The incarceration alert system 120 then receives the information for the second user 101. In certain example embodiments, the incarceration alert system 120 can create a user account 123 with the incarceration alert system 120, such as by using the information provided by the first user 101.

Further, in such example embodiments, when the first user 101 is incarcerated and hence becomes an inmate 103, the incarceration alert system 120 can notify the second user 101 as described herein of the first user's incarceration. That is, the incarceration alert system 120 can, such as described in FIG. 3, identify the first user 101 as the incarcerated inmate 103 by matching a contact record associated with the with the incarceration alert system 120 with the inmate 103. For example, upon receiving and determining the content of an incarceration record as described herein, the incarceration alert system 120 can compare the incarceration record content to the content of one or more contact records associated with the incarceration alert system 120 in order to identify a content match associated with the first user 101. Then, based on the content match, the incarceration alert system 120 can identify the second user 101 as being associated with the inmate/first user 101. The incarceration alert system 120 can then notify the second user 101 of the incarceration, such as described in block 235 of FIG. 2. In certain example embodiments, the incarceration alert system 120 can also optionally notify the inmate 103 that the incarceration alert system 120 has notified the second user 101 of the inmate's incarceration, such as by contacting the inmate 103 via the network 105 and using contact information that the first user 101 previously provided.

In response to being notified of the inmate/first user's incarceration, the second user 101 can, as described herein, beneficially take whatever action is needed to assist the inmate 103. For example, if the second user 101 is the inmate's/first user's attorney, the attorney can quickly initiate steps to provide legal services to the client inmate 103. Additionally or alternately, if the second user 101 is a parent and the inmate 103 is the parent's child, the notified parent can quickly initiate any assistance that their child/inmate 103 might need.

In certain example embodiments, the methods and systems described herein in FIGS. 1-3 can be readily modified and adapted to connect an inmate with an attorney or other legal service provider that can assist the inmate, regardless of whether the inmate has a prior direct relationship with the attorney. Hence, provided is a method for identifying a legal service provider for a user. For example, a first user 101 that wishes to be monitored by the incarceration alert system 120 can enroll with the incarceration alert system 120 as described herein, thereby providing a contact record to the incarceration alert system 120. That is, the first user 101 may contact the incarceration alert system 120 via the network 105 as described herein, such as by accessing the website 122 of the incarceration alert system 120 via the network 105 and inputting information into a user interface of the incarceration alert system 120 to create user account 123 for the first user 101. The incarceration alert system 120 then receives the first user's inputted information via the network 105. The received information for the first user 101 can, for example, serve as contact record described herein, which can be associated with the contact management module 124 of the incarceration alert system 120, as described herein.

In certain example embodiments, the first user 101 may also identify other individuals that the incarceration alert system 120 should contact should the first user 101 becomes an inmate. For example, the first user 101 may provide the mobile phone number of a parent or other relative that the incarceration alert system 120 is to contact if the incarceration alert system 120 determines that the first user 101 has become an inmate 103. Such information, for example, can be associated with the user account 123 of the first user 101 and/or the contact record of the first user 101. The incarceration alert system 120 can then retrieve such information as needed to notify the other individuals.

In addition receiving a contact record for a first user 101, one or more legal service providers, such as an attorney, can register with the incarceration alert system 120. For example, and as described in blocks 205 and 210 of FIG. 2, a legal service provider can contact the incarceration alert system 120 via the network 105 as described herein, such as by accessing the website 122 of the incarceration alert system 120 via the network 105 and inputting information into a user interface of the incarceration alert system 120. The incarceration alert system 120 receives the information, for example, and creates a user account 123 for the legal service provider. In addition to providing information relevant to establishing a user account 123 with the incarceration alert system 120, the legal service provider can identify their legal specialty, such as such as traffic law, DUI defense, assault and battery defense, trespassing defense, drug possession, or other specialties. For example, attorney JANE A. SMITH may provide a specialty indication such as “assault defense.” The incarceration alert system 120 can then receive and store the attorney or other legal provider's information, such as in the data storage unit 125 of the incarceration alert system 120. The incarceration alert system 120 can also receive and store the attorney or other legal provider's specialty indication.

Thereafter, once one or more first users 101 and one or more legal service providers have registered with the incarceration alert system 120, the incarceration alert system 120 can monitor the first user 101 to determine whether the first user 101 becomes incarcerated. For example, and described in blocks 305-315 of FIG. 3 respectively, the incarceration alert system 120 optionally registers with inmate processing system, receives an inmate incarceration record for an inmate 103, and determines the content of the incarceration record. And by determining the content of the incarceration record, the incarceration alert system 120 can identify the first user 101 as an inmate 103. For example, and as described generally in block 320-325, the incarceration alert system 120 reads the received incarceration record to match inmates identified on the incarceration record with the one or more first users 101 that have provided their contact information with the incarceration alert system 120 during the registration process.

In addition to reading the content of the incarceration record to identify a first user 101 as an inmate 103, the incarceration alert system 120 can also read the content of the incarceration record to identify the offense type for which the inmate 103 was arrested. For example, if the first user 101 was arrested for a traffic offense, such as reckless driving, the incarceration alert system 120 can read the incarceration record to determine that the first user 101, now an inmate 103, was arrested for reckless driving and hence that the offense type is a traffic offense. If the first user 101, now an inmate 103, was arrested and incarcerated for driving under the influence, the incarceration alert system 120 can determine that the office type was a traffic violation and more particularly driving under the influence. If, for example, a first user 101 was arrested for assault and becomes an inmate 103, the incarceration alert system 120 determines from the incarceration record that the offense type is assault.

Once the incarceration alert system 120 identifies the first user 101 as an inmate 103 and the offense type for which the inmate 103 was incarcerated, the incarceration alert system 120 compares the determined offense type to the stored specialty indications to determine a match between the inmate's offense type and the specialty area. That is, the incarceration alert system 120 reads the stored specialty indications. The incarceration alert system 120 then determines whether the content of the various stored specialty indications corresponds to the determined offense type. For example, if the offense type is “assault,” the incarceration alert system 120 reads the specialty indications to identify “assault” as a specialty indication. If, for example, the offense type is drug possession, the incarceration alert system 120 reads to the stored specialty indications to identify a drug possession indication.

If the incarceration alert system 120 identifies a match between the offense type and the specialty indications, the incarceration alert system 120 identifies the one or more legal service providers associated with the match. That is, the incarceration alert system 120 determines the identity of the legal service provider that provided the matching specialty indication. For example, if attorney JANE A. SMITH has provided “assault defense” as a specialty indication, and the incarceration alert system 120 has matched an offense type involving assault with the JANE A. SMITH's “assault defense” specialty indication, then the incarceration alert system identifies JANE A. SMITH as being associated with the matched specialty indication. Likewise, if attorney JACK RAMONE has identified “DUI defense” as a specialty, and the incarceration alert system 120 has matched a “DUI defense” offense type with the JACK RAMONE's “DUI defense” specialty indication, then the incarceration alert system identifies JACK RAMONE as being associated with the matched specialty indication.

As those skilled in the art will appreciate, in certain example embodiments multiple attorneys or other legal service providers can enroll with the incarceration alert system 120, and each such attorney or other legal service provider can provide one or more specialty indications. For example, a given attorney may identify a “assault defense” and “traffic offenses” as specialty areas. Hence, in such example embodiments the incarceration alert system 120 can store multiple specialty indications as associated with multiple attorneys or other legal providers. As such, when the incarceration alert system 120 is matching an offense type as described herein—and thereafter identifying the attorney or other legal service provider associated with the specialty indication—the incarceration alert system 120 may identify multiple attorneys or other legal service providers that can assist the inmate. For example, if the first user 101 is incarcerated for assault, the attorney or other legal service provider may identify five attorneys that have identified “assault” as a specialty indication.

In certain example embodiments, once the incarceration alert system 120 identifies one or more attorneys or other legal service providers having a specialty indication associated with the inmate's offense type, the incarceration alert system 120 notifies the inmate 103 of the one or more attorneys or other legal service providers. That is, the incarceration alert system 120 communicates the identity of the identified attorneys or other legal service providers to the inmate 103 via the network. For example, the incarceration alert system 120 can then contact the inmate 103 via a mobile telephone number, such as via a phone call, a text, or any other method. In certain example embodiments, if the inmate 103 has previously identified other individuals to receive the notification, such as a relative, the incarceration alert system 120 can also notify such other individual. For example, if a child first user 101 has provided the mobile number of a parent, and then the child is incarcerated for a traffic offense and hence becomes an inmate 103, the incarceration alert system 120 can notify both the child and the parent of one or more attorneys or other legal service providers that can assist the child.

In certain example embodiments, as part of the notification the incarceration alert system 120 can provide a selectable list of possible attorneys or other legal service providers that the inmate 103 can select. For example, the web server 121 can, via the network 105, provide a user interface to the user device 110 that includes a set of user input options or buttons, each associated with a different attorney or other legal service provider that the incarceration alert system 120 has identified. Such options may also be available to other individuals that the first user 101 (now an inmate 103) has previously provided. For example, the incarceration alert system 120 may provide the notification to a child and the child's parent that the child has been incarcerated and hence also provide a list of five attorneys that can assist the child based on the child's specific offense type.

In certain example embodiments, after providing the notification, the incarceration alert system 120 receives a selection of an identified attorney or other legal service provider that the inmate 103 wishes to use. That is, the inmate 103 or an individual that the inmate has previously identified may select a user input option from the incarceration alert system 120, and thereafter the incarceration alert system 120 receives the selected option via the network 105. For example, if a first user 101 is arrested for “assault” and he receives a list of seven attorneys with “assault” experience, the first user 101 (as the inmate 103) can select a particular one of the identified attorneys. In embodiments where a child has requested a parent, for example, to also receive the notification, the parent can select the user input option from the notification, and then the incarceration alert system 120 receives the selection from the parent.

In certain example embodiments, once the incarceration alert system 120 receives an input selection, such as from a first user 101 (inmate 103) or other individual that the first user 101 (inmate 103) has previously identified, the incarceration alert system 120 notifies the selected legal service provider of the selection. For example, the incarceration alert system 120 can text, email, and/or call the legal service provider, thereby notifying the legal service provider of the selected option. Based on receiving the notification, the legal service provider can then take whatever steps are needed to assist the inmate 103 in a timely manner. For example, the attorney or other legal service provider can quickly provide legal aid to the inmate 103. If the notification includes the court where the inmate 103 is to appear, for example, the attorney can quickly file any motions and/or take any actions with the court to assist the inmate 103.

In certain example embodiments, a first user 101 that has used a legal service provider as described herein may rate the legal service provider. That is, sometime after the legal service provider receives a notification that the first user has been incarcerated, for example, the incarceration alert system 120 may provide a second notification to the first user 101 asking the first user to rate their experience with the legal service provider. For example, the first user 101 may select a rating from 1-5 stars or the like, with five stars being a high rating and one star being a low rating. In such example embodiments, the incarceration alert system 120 can associate the rankings with future notifications. For example, if the incarceration alert system 120 identifies five attorneys having a specialty indication for an “assault” offense type as described herein, the incarceration alert system 120 can provide a ranking associated with each of the five identified attorneys.

### Example Computing Environment

Any suitable computing system or group of computing systems can be used to implement the techniques and methods disclosed herein. For example, FIG. 4 is a block diagram depicting examples hardware implementations of such components, in accordance with certain example embodiments. The computing device 60 can include a processor 61 that is communicatively coupled to a memory 62 and that executes computer-executable program code and/or accesses information stored in memory 62 or storage 63. The processor 61 may comprise a microprocessor, an application-specific integrated circuit (“ASIC”), a state machine, or other processing device. The processor 61 can include one processing device or more than one processing device. Such a processor can include or may be in communication with a computer-readable medium storing instruction that, when executed by the processor 61, cause the processor to perform the operations described herein.

The memory 62 and storage 63 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 60 may also comprise a number of external or internal devices such as input or output devices. For example, the computing device is shown with an input/output (“I/O”) interface 64 that can receive input from input devices or provide output to output devices. A communication interface 65 may also be included in the computing device 60 and can include any device or group of devices suitable for establishing a wired or wireless data connection to one or more data networks. Non-limiting examples of the communication interface 65 include an Ethernet network adapter, a modem, and/or the like. The computing device 60 can transmit messages as electronic or optical signals via the communication interface 65. A bus 66 can also be included to communicatively couple one or more components of the computing device 60.

The computing device 60 can execute program code that configures the processor 61 to perform one or more of the operations described above. The program code can include one or more modules. The program code may be resident in the memory 62, storage 63, or any suitable computer-readable medium and may be executed by the processor 61 or any other suitable processor. In some embodiments, modules can be resident in the memory 62. In additional or alternative embodiments, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

1-23. (canceled)

24. A computer-implemented method for providing an incarceration notification, comprising:
receiving, by one or more computing devices, a contact record from each of a plurality of users, wherein each contact record identifies one or more contacts of each user;
receiving, by the one or more computing devices, an incarceration record for a recently incarcerated inmate, wherein the incarceration record identifies the inmate;
comparing, by the one or more computing devices, the received incarceration record to one or more of the received contact records;
based on the comparison of the one or more contact records to the incarceration record, determining, by the one or more computing devices, a match between at least one of the contact records and the inmate;
identifying, by the one or more computing devices and based on the determined match, at least one of the plurality of users as being associated with the inmate; and
providing a notification to the user regarding the inmate.

25. The computer-implemented method of claim 24, wherein comparing the one or more of the received incarceration record to the received contact records comprises:
determining, by the one or more computing devices, a content of the incarceration record and a content of the contact record; and,
comparing, by the one or more computing devices, the determined content of the incarceration record to the content of the one or more contact records.

26. The computer-implemented method of claim 25, wherein determining the match between at least one of the contact records and the inmate comprises determining a content match between the determined content of the incarceration record and a content associated with one or more of the contact records, wherein the content match associates the inmate with one or more of the users.

27. The computer-implemented method of claim 24, wherein identifying at least one of the plurality of users as being associated with the inmate comprises identifying the user that provided the contact record associated with the inmate.

28. The computer-implemented method of claim 24, wherein the notification informs the user that the inmate has been incarcerated.

29. The computer-implemented method of claim 24, further comprising receiving, by the one or more computing devices, a second contact record, wherein the second contact record is received from the inmate before the inmate is incarcerated and wherein the second contact record identifies a second user.

30. The computer-implemented method of claim 29, further comprising notifying, by the one or more computing devices and based on the identity of the second user, the second user of the incarceration of the inmate.

31. The computer-implemented method of claim 24, wherein the incarceration record identifies an offense that the inmate committed, a court that the inmate will appear in, or a combination thereof and wherein the notification informs the user of the offense that the inmate committed, the court the inmate will appear in, or the combination thereof.

32. A system to provide an incarceration alert notification, comprising:
a storage device;
a processor communicatively coupled to the storage device, wherein the processor executes application code instructions that are stored in the storage device to cause the system to:
receive a contact record from a plurality of first users, wherein each contact record identifies one or more second users;
receive an incarceration record for a recently incarcerated inmate, wherein the incarceration record identifies one of the first users as the inmate;
compare the incarceration record to one or more of the received contact records;
determine, based on the comparison of the one or more contact records to the incarceration record, a match between at least one of the contact records and the inmate;
identify, based on the determined match, at least one second user associated with the inmate; and
provide a notification to the second user regarding the inmate.

33. The system of claim 32, wherein comparing the one or more of the received incarceration records to the received contact records comprises:
determining a content of the incarceration record and a content of the contact record; and,
comparing the determined content of the incarceration record to the content of the one or more contact records.

34. The system of claim 33, wherein determining the match between at least one of the contact records and the inmate comprises determining a content match between the determined content of the incarceration record and a content associated with one or more of the contact records, wherein the content match associates the inmate with one or more of the users.

35. The system of claim 32, wherein identifying at least one of the plurality of users as being associated with the inmate comprises identifying the user that provided the contact record associated with the inmate and wherein the notification informs the user that the inmate has been incarcerated.

36. The system of claim 32, further comprising:
receiving a second contact record, wherein the second contact record is received from the inmate before the inmate is incarcerated and wherein the second contact record identifies a second user; and,
based on the identity of the second user, notifying the second user of the incarceration of the inmate.

37. The system of claim 32, wherein the incarceration record identifies an offense that the inmate committed, a court that the inmate will appear in, or a combination thereof and wherein the notification informs the user of the offense that the inmate committed, the court the inmate will appear in, or the combination thereof.

38. A computer program product comprising:
a non-transitory computer-readable storage device having computer-readable program instructions embodied thereon that when executed by a computer cause the computer to provide combined alert notifications, the computer-executable program instructions comprising:
computer program instructions to receive a contact record from each of a plurality of users, wherein each contact record identifies one or more contacts of each user;
computer program instructions to receive an incarceration record for a recently incarcerated inmate, wherein the incarceration record identifies the inmate;
computer program instructions to compare one or more of the received contact records to the incarceration record;
computer program instructions to determine, based on the comparison of the one or more contact records to the incarceration record, a match between at least one of the contact records and the inmate;
computer program instructions to identify, based on the determined match, at least one of the plurality of users as being associated with the inmate; and
computer program instructions to provide a notification to the user regarding the inmate.

39. The computer program product of claim 38, wherein comparing the one or more of the received incarceration records to the received contact records comprises:
determining a content of the incarceration record and a content of the contact record; and,
comparing the determined content of the incarceration record to the content of the one or more contact records.

40. The computer program product of claim 39, wherein determining the match between at least one of the contact records and the inmate comprises determining a content match between the determined content of the incarceration record and a content associated with one or more of the contact records, wherein the content match associates the inmate with one or more of the users.

41. The computer program product of claim 38, wherein identifying at least one of the plurality of users as being associated with the inmate comprises identifying the user that provided the contact record associated with the inmate and wherein the notification informs the user that the inmate has been incarcerated.

42. The computer program product of claim 38, further comprising:
receiving a second contact record, wherein the second contact record is received from the inmate before the inmate is incarcerated and wherein the second contact record identifies a second user; and,
based on the identity of the second user, notifying the second user of the incarceration of the inmate.

43. The computer program product of claim 38, wherein the incarceration record identifies an offense that the inmate committed, a court that the inmate will appear in, or a combination thereof and wherein the notification informs the user of the offense that the inmate committed, the court the inmate will appear in, or the combination thereof.
